(19) United States
(12) Patent Application Publication
(10) Pub. No.: US 2006/0207132 A1
(43) Pub. Date: Sep. 21, 2006

(54) Reusable personalized beverage identifier

(76) Inventors: Marion M. Vaughan, Palm Beach Gardens, FL (US); Jefferson Vaughan, Palm Beach Gardens, FL (US)

Correspondence Address: SACCO & ASSOCIATES, PA, P.O. BOX 30999, PALM BEACH GARDENS, FL, 33420-0999, US

(21) Appl. No.: 11/176,705

(22) Filed: Jul. 7, 2005

Related U.S. Application Data
(60) Provisional application No. 60/641,305, filed on Jan. 4, 2005.

(51) Int. Cl. G09F 3/00

(52) U.S. Cl. 40/310

(57) ABSTRACT

System for identifying a specific beverage container among a group of beverage containers. The system can include an elastic band sized for elastically engaging an outer surface of an individual beverage container, and a tag secured to the elastic band. The tag can be removably secured to the elastic band by a clip. The tag can include at least one surface for displaying identifying indicia thereon in such a way as to permit the identifying indicia to be repeatedly changed or altered by a user.

### CROSS REFERENCES TO RELATED APPLICATIONS

This application claims benefit of U.S. provisional patent application Ser. No. 60/641,305 filed Jan. 4, 2005, which application is herein incorporated by reference.

### BACKGROUND OF THE INVENTION

1. Statement of the Technical Field

The inventive arrangements relate generally to the field of products useful for identifying personal items, and more particularly to personalized beverage identifiers that are reusable.

2. Description of the Related Art

Identification of a specific beverage container among a group of beverage containers can be difficult. This is particularly true where the group of beverage containers is of the same design and/or brand of beverage. Various systems have been proposed to address these problems. For example, U.S. Pat. Nos. 5,704,144, 5,358,770 and 5,339,549 all disclose systems that can be used to identify a beverage container as belonging to a particular person. Still, none of the approaches described in such references have been widely accepted.

One possible reason is for the lack of market acceptance of existing systems may be the relatively cumbersome devices used to mark beverage containers using those systems. The size, configuration, and/or attachment mechanisms can make the beverage container awkward to hold. Yet another reason such beverage container identification systems may not have received wide acceptance is that they do not facilitate fast and easy marking to identify beverages as belonging to specific individual. Finally, many of the available systems are not reusable insofar as they do not permit the same identification device to be easily reused by different people with different names.

### SUMMARY OF THE INVENTION

The invention concerns a system for identifying a specific beverage container among a group of beverage containers as belonging to a particular individual among a group of individuals. The system can include an elastic band sized for elastically engaging an outer surface of an individual beverage container, and a tag secured to the elastic band. The tag can be removably secured to the elastic band by a clip. For example, a slip ring or other type of clip can be used for this purpose.

The tag can include at least one surface for displaying identifying indicia thereon. According to one aspect, the surface for displaying identifying indicia can be formed in such a way as to permit the identifying indicia to be repeatedly changed or altered by a user. More particularly, the surface can be a markable writing surface, capable being marked upon by a felt tip pen, marker, ink pen, or other writing instrument. The marking surface can be formed of a glossy plastic or from any other material that can facilitate marking and subsequently erasing the marking from the tag. The body of the tag can be formed from a metal or plastic material.

The system can also include secondary identifying indicia. For example, the secondary identifying indicia can be determined based on a color applied to the elastic band, the tag or to both. In addition to, or as an alternative to such secondary indicia, at least one surface of the tag can include advertising. Likewise, the elastic band can include an advertising message.

### BRIEF DESCRIPTION OF THE DRAWINGS

FIG. 1 is perspective view of an embodiment of the invention.

FIG. 2 is a perspective view of an embodiment of the invention shown disposed on a beverage container.

### DETAILED DESCRIPTION OF THE PREFERRED EMBODIMENTS

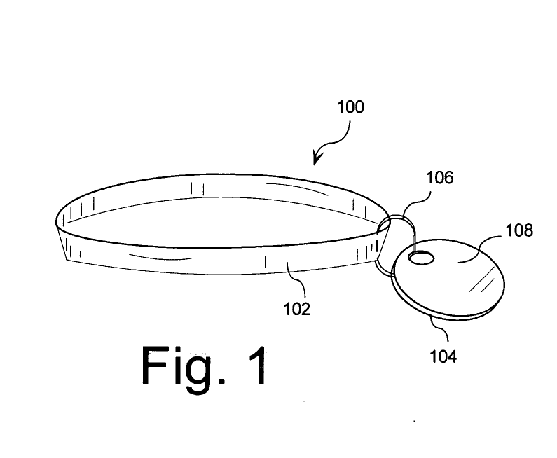

A system 100 for identifying a specific beverage container among a group of beverage containers is illustrated in FIG. 1. The system 100 can be used to identify a specific beverage container as belonging to a particular individual among a group of individuals.

Referring to FIG. 1, it can be observed that the system 100 can include an elastic band 102. The elastic band can be formed from any of a wide variety of known elastic materials suitable for creating elastic bands. For example, the elastic band can be made from natural rubber; synthetic polyisoprene; an ethylene propylene rubber such as Ethylene Propylene Diene Monomer (EPDM); or silicone compounds. Still, the invention is not limited with regard to the specific material from which the elastic band is formed.

The elastic band 102 can be sized for elastically engaging an outer surface of a beverage container sized for individual consumption. Typically, cylindrical containers of this type have a diameter that ranges in size from about 1.5 inches to about 3 inches, depending upon the particular style of can or bottle. For example, the approximate diameter of a typical 12 oz. aluminum beverage can is about 2 and ⅜ inches, which produces a circumference of about 7.5 inches. Accordingly, an elastic band suitable for such cans could advantageously be selected to have a circumference that is less than about 7.5 inches.

The minimum size of the band should be selected so that an excessive amount of tension is not required in order to stretch the band around the circumference of the beverage container. For example, a band having a circumference of about 7 inches and a width of about ⅜ inches could be used in the case of a standard 12 ounce beverage can. Still, those skilled in the art will appreciate that the invention is not limited to any specific size band. Instead, the exact size of the band will depend upon a variety of factors including the elasticity of the band material, the thickness of the band material, and the size of the particular type beverage container for which the band is designed. All that is required is that the band provide a snug fit around the beverage container.

Referring once again to FIG. 1, a tag 104 can be secured to the elastic band 102. The tag 104 can advantageously be selected to be a hanging tag that is secured to the elastic band by a clip 106. For example the clip 106 can be a slip ring formed of metal, plastic or any other type of suitable material. Still, any other type of clip can be used for this purpose provided that it allow the tag 106 to be easily removed from the band 102 and replaced with a substitute tag of similar design.

The tag 106 can include at least one surface 108 for displaying identifying indicia thereon. As used herein, the term identifying indicia means any alphanumeric marking applied to the surface of the tag 106 that is capable of identifying one beverage container from other similar beverage containers. For example, the term identifying indicia can include markings applied to the surface 108 with a marking pen or other writing instrument. The surface 108 for displaying identifying indicia can be formed of a material that can be permanently marked with a marking pen. For example a porous or absorbent type surface formed of paper, fabric web or some other type material, can be used for this purpose. Use of a permanent type marking surface can be useful where the system is intended only for use by a single individual at all times.

In some instances it can be desirable to use the same identifying system on different occasions to identify beverage containers belonging to different individuals. In that case, it can be advantageous to form the surface 108 from a material that will permit the identifying indicia applied thereto to be repeatedly erased, changed and/or altered by a user. A variety of different materials can be used for this purpose. Generally, such materials are smooth, non porous surfaces that will permit ink from a marking pen to applied to the surface and subsequently wiped clean. For example, the marking surface 108 can be formed of a hard glossy plastic.

As used herein, the term plastic should be understood to include a range of synthetic or semi-synthetic organic condensation or polymerization products, excluding the rubbers, which can be molded or extruded into objects or films and/or fibers. Plastics are also understood to include various materials that contain as an essential ingredient an organic substance of large molecular weight, are solid in their finished state, and, at some stage in their manufacture or processing into finished articles, can be shaped by flow.

The surface 108 can generally be formed from any material that is capable of being marked and subsequently erased. Examples of material that can be used to form the tag 104 can also include plastic laminates, formed from various materials such as melamine resin, composition chalkboard material, a porcelain skin over metal base material, or any other material that can facilitate marking and subsequently erasing the marking from the tag. In order to ensure proper marking, the system can also include one or more water soluble markers, dry-erase marker pens or markers formed from chalk. Marking pens and markers of this type are well known in the art.

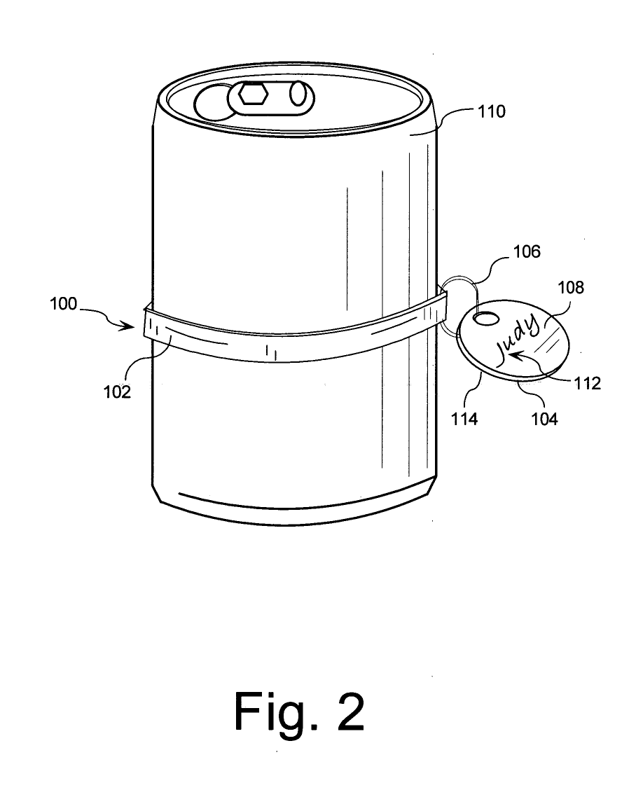

Referring now to FIG. 2, the system 100 is shown disposed on a beverage container 110. Further, in FIG. 2, an identifying indicia 112 has been applied to the surface 108. As a result of the identifying indicia, the beverage container can be easily identified. When the beverage is consumed, the identifying indicia can be easily removed. On subsequent occasions when the identifying system is needed, new identifying indicia can be applied corresponding to a different individual.

The system 100 described herein can also include secondary identifying indicia. For example, the secondary identifying indicia can be determined based on a color applied to the elastic band 102, the tag 104 or to both items. Individuals can more easily identify beverage containers from a greater distance by including such secondary identifying indicia. In order to make a more positive identification of the beverage container, the identifying indicia 112, which is the primary identifying indicia, can be referred to.

As an alternative to such secondary indicia, at least one surface of the tag can include advertising. As used herein, the term advertising refers to any image, logo, text, or combination of these that communicates a message other than the identifying indicia described herein. The advertising can advantageously appear on a side 114 of the tag 104 that is opposed from the identifying indicia 112. Leaving the surface 108 available for marking with advertising indicia. Likewise, the elastic band can also include an advertising message.

While the foregoing description is directed to the preferred embodiment of the present invention, other and further embodiments of the invention may be devised without departing from the basic scope thereof. Accordingly, the scope of the present invention should be determined by the claims that follow.

We claim:

1. A system for identifying a specific beverage container among a group of beverage containers as belonging to a particular individual among a group of individuals, comprising:
an elastic band sized for elastically engaging an outer surface of a individual beverage container; and
a tag secured to said elastic band, said tag having at least one means for displaying an identifying indicia.

2. The system according to claim 1, wherein said means for displaying an identifying indicia further comprises means for repeatedly altering said identifying indicia.

3. The system according to claim 2, wherein said means for repeatedly altering said identifying indicia comprises a markable writing surface.

4. The system according to claim 3, wherein said markable writing surface is formed of a glossy plastic.

5. The system according to claim 3, further comprising means for marking and means for erasing said marking from said tag.

6. The system according to claim 1, wherein said tag is formed from a plastic material.

7. The system according to claim 1, wherein said tag is removably secured to said elastic band by a clip.

8. The system according to claim 1, comprising means for displaying a further identifying indicia.

9. The system according to claim 8, wherein said further identifying indicia is a color applied to at least one of said elastic band and said tag.

10. The system according to claim 9, wherein said further identifying indicia is a combination of a color of said elastic band and a color of said tag.

11. The system according to claim 1, wherein at least a second surface of said tag comprises advertising.

12. A system for identifying a specific beverage container among a group of beverage containers as belonging to a particular individual among a group of individuals, comprising:
an elastic band sized for elastically engaging an outer surface of a individual beverage container; and
a tag secured to said elastic band, said tag having at least one erasable writing surface for displaying an identifying indicia that can be repeatedly changed to personally identify a plurality different individuals.

13. The system according to claim 12, wherein said erasable writing surface is formed of a glossy plastic.

14. The system according to claim 12, comprising means for displaying a further identifying indicia.

15. The system according to claim 14, wherein said further identifying indicia is a color applied to at least one of said elastic band and at least a portion said tag.

16. The system according to claim 15, wherein said further identifying indicia is a combination of a color of said elastic band and a color of said tag.

17. The system according to claim 12, wherein at least one surface of said tag comprises advertising.

18. The system according to claim 12, wherein at least a portion of said elastic band comprises advertising.

19. A system for identifying a specific beverage container among a group of beverage containers as belonging to a particular individual among a group of individuals, comprising:
an elastic band sized for elastically engaging an outer surface of a individual beverage container;
a tag secured to said elastic band, said tag having at least one erasable writing surface formed of a glossy plastic for displaying an identifying indicia that can be repeatedly changed to personally identify a plurality different individuals;
and wherein said elastic band and said tag each have at least one surface that has a color, said combination of colors serving as a second identifying indicia.

20. The system according to claim 19, wherein at least a portion of said elastic band comprises advertising.
